(19) United States
(12) Patent Application Publication
(10) Pub. No.: US 2002/0010922 A1
(43) Pub. Date: Jan. 24, 2002

(54) Active program notification system and method

(76) Inventors: Shai Darin, Tel Aviv (IL); Michael Weinberg, Tel Aviv (IL); Danny Ehrenfeld, Tel Aviv (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/771,629

(22) Filed: Jan. 30, 2001

Related U.S. Application Data
(60) Provisional application No. 60/179,014, filed on Jan. 31, 2000.
(60) Provisional application No. 60/264,284, filed on Jan. 29, 2001.

(51) Int. Cl. H04N 7/025

(52) U.S. Cl. 725/32

(57) ABSTRACT

There is disclosed a system provides a television viewer with notification of a program, selected in accordance with previously entered individual viewer parameters. Notification is typically in real time and typically by a visual indicator, such as a pop-up message, crawler or the like, on the television or monitor screen. The visual indicator is such that it enables the viewer to interact with it and switch the television to that program indicated in the visual indicator.

### CROSS REFERENCES TO RELATED APPLICATIONS

This patent application claims priority from U.S. Provisional Patent Application Ser. No. 60/179,014, filed on Jan. 31, 2000, this U.S. Provisional Patent Application incorporated by reference in its entirety herein.

### TECHNICAL FIELD

The present invention is directed to video applications and in particular to interactive systems and methods for notifying a viewer of various programs (single or multiple, also referred to as events) in real time and in response to a signal from that viewer, to switching to the notified program.

### BACKGROUND

Television is one of the most popular communication mediums in the world today. As technology advances, the number of available viewing options increases. For example, the advent of cable and satellite systems provide increasing numbers of channels and programs.

With this increase in channels and programs, the once simple television schedule, typically printed or displayed onscreen, is becoming complex and voluminous, to a point where it is difficult to memorize or review an exhaustive schedule or on-screen guide. Coupled with new channels being added or channels subtracted from cable and satellite systems, and unannounced changes in programming schedules, these television schedules may be inaccurate, and as a result, the viewer may miss a program they desired to see.

Several systems have been developed to assist viewers in not missing their desired programs. For example, a system known as VCR PLUS® (Gemstar Development Corporation, Pasadena, Calif.), allowed viewers with a special remote control to enter a numeric code for the desired program, as listed in a schedule or the like. The corresponding VCR would then tape the coded program. Alternately, there are now remote controllers, from which a cable or satellite television viewer can use to either enter a code from a schedule or the like, or select a program from an on-screen guide or menu, also known as Electronic Program Guide (EPG). When that program airs, it may turn the television on, to that program, or should the television be on, it will change channels to that program.

These systems continue to exhibit drawbacks, in that they are passive, requiring user intervention. This is because the user (viewer) must first make selections to specific programs, at a time before these programs air, so as to receive them from these systems. Otherwise, the viewer will not receive any notice of these programs from these systems, and absent manually accessing these programs by changing the channel or entering the channel into a remote control device, the user will miss these programs.

### SUMMARY

The present invention improves on the prior art on-screen guides (EPG), and other Television schedules, by providing an active program notification system (APNS) for programs (single or multiple, also referred to as events). This active program notification system provides the viewer with notification of a program (or event), provided to the viewer in accordance with previously entered parameters. Notification is typically in real time and typically by a visual indicator, such as a pop-up message, crawler or the like, on the television or monitor screen. The visual indicator is such that it enables the viewer to interact with it and switch the television to that program indicated in the visual indicator.

The system is such that it can be programmed by the user to accommodate individual user preferences, and accordingly, only notify them of the type of programming desired, for example, comedies, sports, etc. The user's programming preferences need only be obtained once, upon entry into the system, or whenever user preferences are changed. As a result, the user does not have to make changes to these preferences during normal operation.

In one embodiment of the present invention, there is provided a method for notifying a viewer of at least one event, typically a program, on a viewing device, such as a television screen or monitor. This method includes monitoring at least one transmission signal and extracting information from this at least one transmission signal. This information corresponds to data entered into a database. Notification for the at least one event from the extracted information is then provided to the viewer, typically by a visual or audio indication, and a mechanism is provided to the viewer for responding to the notification. This mechanism is such that it allows the viewer to respond, such that the response results in the channel on the viewing device being changed, such that the viewer can view the at least one event (program or programs) for which they received notification thereof.

In another embodiment, there is a system for notifying a viewer of at least one event (program) on a viewing device. The system includes a storage device for storing data entered into the storage device by the viewer (user) and a microprocessor, typically a CPU, coupled to the storage device. The microprocessor is programmed for: monitoring at least one transmission signal; extracting information from this at least one transmission signal, the information corresponding to the stored data; providing a notification for the at least one event from said extracted information; and providing at least one mechanism for responding to this notification. The microprocessor is additionally programmed for providing at least one mechanism for switching the viewing device to the at least one event (program), as a response to the notification, for that particular event or program.

In another embodiment, the present invention can be provided in software as a computer-usable storage medium having a computer program embodied thereon for causing a suitably programmed system to notify a user of a desired event, typically a television program. When this computer program is executed on the aforementioned system, the following steps will be performed, these steps including: monitoring at least one transmission signal; extracting information from this at least one transmission signal, this information corresponding to the stored data, typically in a user database in a storage unit, this stored data having been entered into the system by a viewer (user); providing a notification for said at least one event from said extracted information; and providing at least one mechanism for responding to the notification by the viewer (user). This mechanism typically allows for the channel to be changed to the event or program that the viewer was notified of, by the viewer.

### BRIEF DESCRIPTION OF THE DRAWINGS

Attention is now directed to the drawing figures, where corresponding or like numerals or reference characters indicate corresponding or like components. In the drawings:

FIG. 1 is a diagram illustrating an embodiment of the present invention;

FIG. 2 is an exemplary menu for a set-up application as displayed on-screen in accordance with an embodiment of the present invention;

FIG. 3 is a flow diagram of an exemplary process in accordance with an embodiment of the present invention; and

FIG. 4 is a screen shot of an application in accordance with an embodiment of the present invention.

### DETAILED DESCRIPTION OF THE DRAWINGS

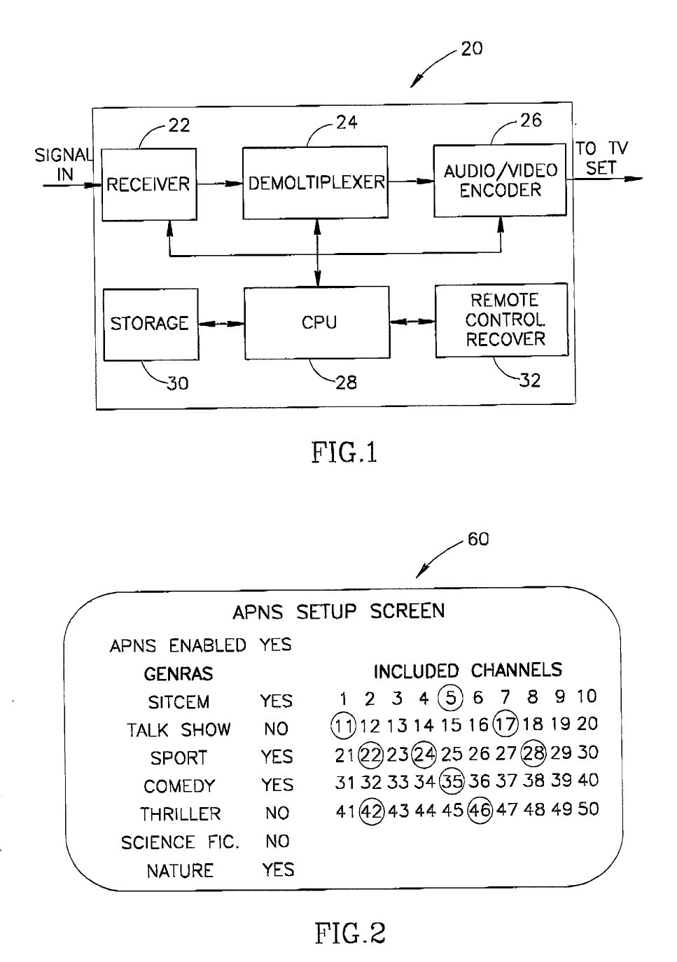

FIG. 1 details an apparatus 20, typically in the form of a small box, commonly known as a set-top box (STB), or the like that can be seated on top of, or lateral to, a television or other video display device. The system of the present invention will be described for exemplary purposes with televisions that receive transmissions from satellite, cable or antennae. However, television systems useful in accordance with the present invention can also include those that receive transmissions via the world wide web or other wide or local area network. The system of the present invention described below is exemplary, as it can be implemented exclusively in software or hardware, in addition to the exemplary combination of hardware and software detailed below.

This apparatus 20 is programmable by a user (viewer), as well as operable by this user, typically through a remote control (e.g., infra-red) or other data entry device, or by using keys on the apparatus itself. The apparatus 20 is also configured with hardware, software or combinations thereof, for receiving user input and matching programs with this input, notifying the user of these programs conforming to the user input, and changing the channel to the program conforming to the user input, upon receiving a signal from the user, as detailed below.

The apparatus 20 includes a receiver 22, demultiplexer 24, Audio/Video encoder 26, CPU 28, storage unit 30 and Remote Control Receiver 32. These components of the apparatus 20 are arranged therein so as to be in electronic communication with each other.

The receiver 22 is capable of receiving a modulated signal from satellite, cable, antenna or any other video transmission signal. The output of the receiver 22 is a signal that carries multiple channels, multiplexed into a single stream.

The demultiplexer 24 extracts a single channel from a multiplexed stream that carries multiple channels. The demultiplexer 24, as programmed by the CPU 28, monitors the transmission signal(s) and extracts programs (single or multiple, also known as events) as well as information associated with present or future programs (events), that are being transmitted or will transmitted on the various system channels from the requisite transmission signal(s). The demultiplexer complies with a television transmission standard, such as DVB (Digital Video Broadcasting), or any other standards that support transmission of multiple channels.

The Audio/Video Encoder 26 constructs a Video/Audio signal in a format suitable for on-screen display on the television or the like. The Video/Audio encoder is capable of displaying overlaid messages or symbols, typically by displaying a text message and/or a symbol on the screen while a video program is in the background. This capability is used to display the notification message.

The CPU 28 is coupled with all components and controls and coordinates operation of all components of the apparatus 20. The CPU 28 has programming capabilities and is capable to execute the APNS functionality of the invention (detailed below), as well as all other STB functionalities.

The storage unit 30 is typically any conventional storage or memory unit. This storage is typically configured to hold software and or data, including, for example, software necessary for normal operation of the apparatus 20 or STB, software for running the functionalities of the system of the invention, set-up applications, user databases, etc.

The Remote Control Receiver 32 receives signals from the user's Remote Control device or any other signaling unit. The Remote Control device may generate Infrared signals or any other signals that will be received by the Remote Control Receiver 32.

During normal operation, the output of the receiver 22, which carries multiple channels, is forwarded to the demultiplexer 24. The demultiplexer 24 extracts the selected channel and passes it to the Audio/Video encoder 26. The Audio/Video encoder 26 constructs an Audio/Video signal that is displayed on the TV screen or any other display device. The CPU 28 controls all these components.

The demultiplexer 24, coupled with the CPU 28, as detailed above, monitors the transmission extracts program information about programs of all channels from the incoming signal(s) (received from the receiver 22) and routs it to the CPU 28. The CPU 28 executes the Active Program Notification System (APNS) functionality by comparing the incoming program information with the stored user's preferences. Upon match, the CPU 28 constructs a notification message (such as banner or crawler), including minimal information about the suggested program (e.g., program name and channel). The notification message is forwarded to the encoder 26, which displays it on the user's display device (typically, a Television, also known as a TV) as an overlaid message, while the current program is being displayed at the background.

The remote control receiver 32 is configured for receiving signals from a remote control or other signaling unit. Within this remote control receiver is circuitry (including hardware and/or software) for setting the system of the present invention and allowing user interaction therewith, including responses thereto.

While the above description is general for a STB for the apparatus of the present invention, other commercially available STB's are also suitable as the apparatus 20 of the present invention. These other commercially available STB's would be modified with the software (and databases) and/or hardware necessary for running the system of the invention. For example, other STB's that may be used as the apparatus 20 of the present invention include, PACE®, Model DSR 630 (Pace Micro Technology Limited, Shipley West Yorkshire BD18 3LF, England), or ADB ABS-6642, from ADB Poland. These alternate STB's can be configured to accommodate cable, satellite, antennae, or any other video signal transmission.

An exemplary operation of this active program notification system functionality, will now be described with reference to FIG. 2. Here, the system is initially in a steady state with user preferences for various types of programming having been previously programmed or entered into the system, in a set-up application 60. This set-up application 60 is typically an on-screen application for visual display on the television screen of the user. As stated above, all selections on this set-up application are operable by a conventional remote control or other data entry device, as detailed above. From this set-up application, the user will set his preferences, that will remain in effect until the system is disabled, either manually or automatically, or changed by the user. These preferences are entered into a database (user database) in the storage unit 30.

This set-up application 60, is exemplary, as the functions, also known as parameters, listed below may be added to or deleted as desired. A first function can be directed to enabling or disabling the system, here labeled “APNS Enabled”. Another function is directed to channels, with channels 1-50 shown, but any number of channels is possible, and can be added as desired. This function is labeled “Included Channels”. Here, for example, the circled channels (5, 11, 17, 22, 24, 28, 35, 42 and 46) have been selected.

Another function includes “Genres” or types of programming, here for example, “Sitcom”, “Talkshow”, “Sport”, “Comedy”, “Thriller”, “Science Fiction” and “Nature”. Other types of programming genres can be added or deleted as desired. These programming types of genres are typically based on those classifications provided to in the signal from the cable or satellite provider or the local broadcaster, in cases of antenna transmission. This setup application allows the user (viewer) to define the genres and the channels that they desire. Whenever a program that matches a requested genre is going to be transmitted on one of the included channels, a notification message will appear on the screen, suggesting the user to switch to program's channel.

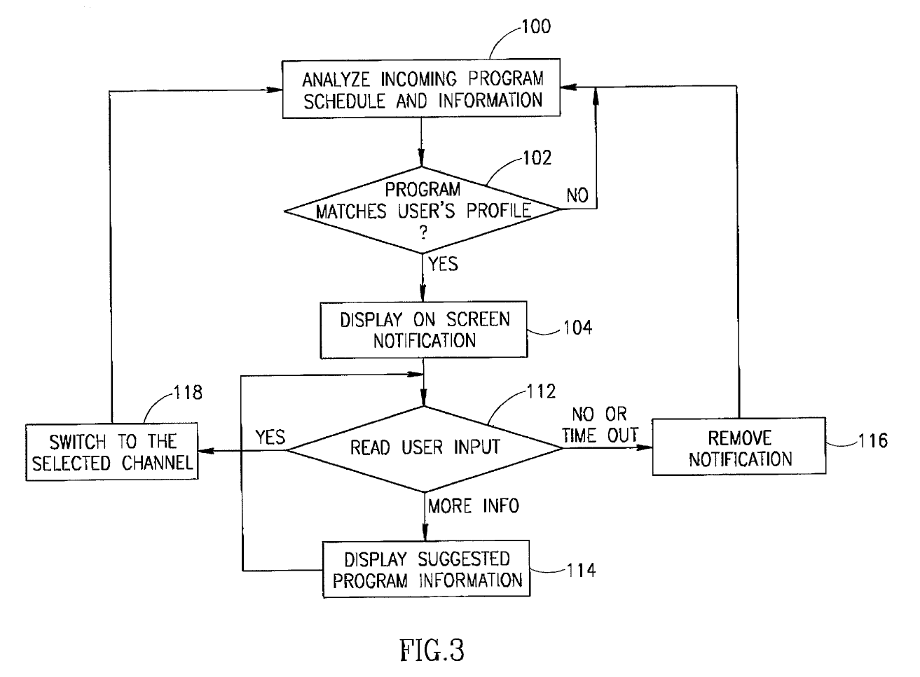

Turning also to FIG. 3, with the system now set-up, the system analyzes incoming programs schedules and information, with specific programming genres or types and other associated information embedded in the transmission signal corresponding to the program as sent by the various television, satellite, cable systems, local broadcasters or the like, at block 100. The apparatus 20 is configured with the requisite hardware, software or combinations thereof, in accordance with the various television signal transmission standards, for example Digital video Broadcasting (DVB), or with the ability to detect the standard and adjust the system accordingly, for the standard(s) as used by the various television, satellite, cable systems, local broadcasters or the like, as detailed above, to accept these embedded program information signals. In the apparatus 20, this typically occurs in the demultiplexer 24 and the CPU 28.

The transmission signal is monitored, such that information from the signal, corresponding to programs and other associated information can then analyzed for a match with data as to desired programming, previously entered by the user into a user database of the storage unit 30 (in the above described set-up application), at block 102. If there is not a match, the system continues its search, returning to block 100.

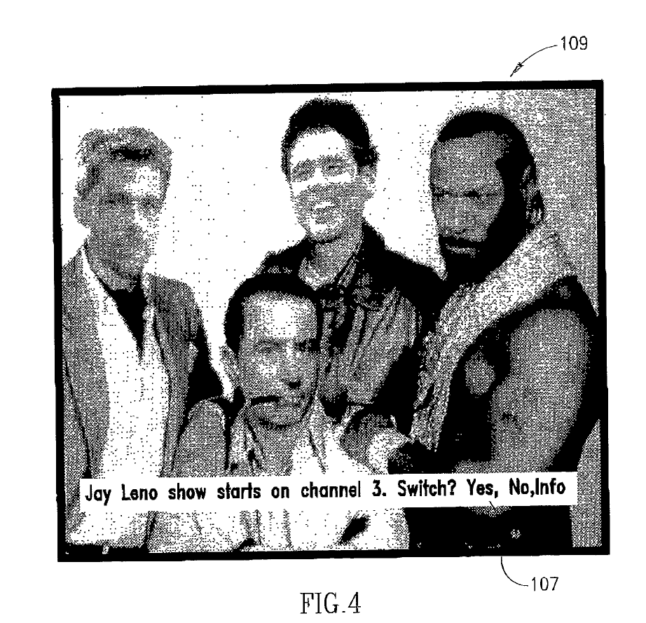

If there is a match, a notification is displayed on the television screen or monitor of the user, at block 104. One method of on-screen notification is an overlaid on-screen display, such as a text banner 107, notifying the user of a show on the screen 109 and requesting the user decide if he wants to change channels to view this show, in FIG. 4. This visual notification can be combined with, or replaced by audio, typically in the form of an alarm sound, so as aurally alert the viewer of upcoming program.

The system then waits a predetermined (preprogrammed) time for user input, at block 112. If the user selects an option for “info”, corresponding to more information, the user will receive additional information as to that program, at block 114. This additional information may include for example, content for children, adults, etc., language, rerun, program duration, program summaries, that can appear as text or symbols or combinations thereof. While displaying this additional information, the system will again wait to read user input, at block 112. If the user selects “no”, for do not change to this program, or the predetermined time elapses without a selection, the text banner 107 is removed, at block 116 and the system returns to its original state at block 100.

If the user selects “yes” typically by activating the remote control or other similar device, a channel change is made, at block 118. The system then returns to its initial configuration at block 100.

The methods and apparatus disclosed herein have been described with exemplary reference to specific hardware and/or software. The methods and apparatus have been described in a manner sufficient to enable persons of ordinary skill in the art to readily adapt other commercially available hardware and software as may be needed to reduce any of the embodiments of the present invention to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims.

What is claimed is:

1. A method for notifying a viewer of at least one event on a viewing device comprising:
monitoring at least one transmission signal;
extracting information from said at least one transmission signal, said information corresponding to data entered into a database;
providing a notification for said at least one event from said extracted information; and
providing at least one mechanism for responding to said notification.

2. The method of claim 1, additionally comprising:
providing at least one mechanism for switching said viewing device to said at least one event.

3. The method of claim 1, wherein said extracting includes comparing information in said monitored signal with said information corresponding to data entered into said database.

4. The method of claim 1, wherein said providing a notification includes providing a visual notification.

5. The method of claim 1, wherein said providing a notification includes providing an aural notification.

6. The method of claim 2, wherein said at least one event includes at least one program.

7. A system for notifying a viewer of at least one event on a viewing device comprising:
a storage device for storing data entered into said storage device;
a microprocessor coupled to said storage device, said microprocessor programmed for:
monitoring at least one transmission signal;
extracting information from said at least one transmission signal, said information corresponding to said stored data;
providing a notification for said at least one event from said extracted information; and
providing at least one mechanism for responding to said notification.

8. The system of claim 7, wherein said microprocessor is additionally programmed for;
providing at least one mechanism for switching said viewing device to said at least one event.

9. The system of claim 7, wherein said extracting includes comparing information in said monitored signal with information corresponding to said stored data.

10. The system of claim 7, wherein said providing a notification includes providing a visual notification.

11. The system of claim 7, wherein said providing a notification includes providing an aural notification.

12. The system of claim 7, wherein said at least one event includes at least one program.

13. A computer-usable storage medium having a computer program embodied thereon for causing a suitably programmed system to notify a user of a desired event by performing the following steps when such program is executed on the system:
monitoring at least one transmission signal;
extracting information from said at least one transmission signal, said information corresponding to data stored in a user database;
providing a notification for said at least one event from said extracted information; and
providing at least one mechanism for responding to said notification.
